(19) United States
(12) Patent Application Publication
(10) Pub. No.: US 2025/0043530 A1
(43) Pub. Date: Feb. 6, 2025

(54) REINFORCED ANTI-SEISMIC STRUCTURE SUITABLE FOR URBAN UNDERGROUND COMPREHENSIVE PIPE GALLERY

(71) Applicants: Muci YUE, Shijiazhuang (CN); Xiuling CAO, Shijiazhuang (CN); HEBEI GEO UNIVERSITY, Shijiazhuang, Hebei (CN)

(72) Inventors: Xiuling CAO, Shijiazhuang (CN); Muci YUE, Shijiazhuang (CN); Liang YU, Shijiazhuang (CN); Xiaohong QU, Shijiazhuang (CN); Junfeng WANG, Shijiazhuang (CN); Congxu YANG, Shijiazhuang (CN); Anguelov K. A., Shijiazhuang (HB); CASAGLI N., Shijiazhuang (CN); Xinzhi LIU, Shijiazhuang (CN); Zihan FENG, Shijiazhuang (CN); Shuo HAN, Shijiazhuang (CN)

(73) Assignees: Muci YUE, Shijiazhuang, HB (CN); Xiuling CAO, Shijiazhuang, HB (CN)

(21) Appl. No.: 18/715,752

(22) PCT Filed: Jul. 1, 2022
(86) PCT No.: PCT/CN2022/103391

§ 371 Date: Jun. 3, 2024

(30) Foreign Application Priority Data
Dec. 3, 2021 (CN) 202111465951.2

(51) Int. Cl. E02D 29/00; F16L 3/223; F16L 55/035

(52) U.S. Cl. CPC E02D 29/10; F16L 3/2235; F16L 55/035

(57) ABSTRACT

The invention discloses an enhanced anti-seismic structure suitable for urban underground comprehensive pipe galleries. Comprising a polygonal frame with an outer frame and an inner frame arranged inside it. Vertex of the inner frame is connected to the bending position inside the outer frame via a support rod. Outer frame has installation grooves for pipe installation, corresponding one-to-one with its sides. The outer frame, located outside the installation groove, can be disassembled to install a limit frame. A limit mechanism for fixing the pipe is installed on the limit frame. The outer frame, positioned outside the installation slot, can be disassembled to install a limit frame. Screwing in a screw drives a lifting block to compress a spring, causing a top block to press against the pipe surface and secure it. The polygonal frame allows for multiple pipes to be installed simultaneously, enhancing overall stability through the support rod connections.

### TECHNICAL FIELD

The invention relates to the technical field of anti-seismic pipe galleries, in particular to an enhanced anti-seismic structure suitable for urban underground comprehensive pipe galleries.

### BACKGROUND TECHNIQUE

At present, due to the large number of pipelines in the city's pipe gallery, the whole pipe gallery is installed in a tunnel-type construction method. The whole pipe gallery is built in the soil layer in the form of a tunnel row, and multiple groove frames for installing pipelines are erected inside the pipe gallery. In actual earthquake disasters When it occurs, the whole pipe gallery tunnel will produce overall vibration displacement in the seismic longitudinal and transverse waves, and the expansion and contraction rates of different soil layers can easily lead to the problem of cracks or even collapse of the tunnel. The trough frame of the corridor tunnel will fall off and be damaged directly, resulting in the tripping and damage of the pipeline.

Therefore, in view of the above status quo, it is urgent to develop a reinforced seismic structure suitable for urban underground comprehensive pipe gallery to overcome the deficiencies in current practical applications.

### SUMMARY OF THE INVENTION

The purpose of the present invention is to provide a reinforced anti-seismic structure suitable for urban underground comprehensive pipe gallery, so as to solve the problems raised in the above background technology.

To achieve the above object, the present invention provides the following technical solutions:

An enhanced anti-seismic structure suitable for urban underground comprehensive pipe gallery includes a polygonal frame, the polygonal frame comprises an outer frame and an inner frame arranged inside the outer frame, and the vertex of the inner frame is fixedly connected with the bending position inside the outer frame through a support rod; An installation groove for pipe installation is arranged at the side outside the outer frame, and the installation groove corresponds to the side of the outer frame one by one. The outer frame is located at the outside of the installation groove and can be disassembled to install a limit frame. A limit mechanism for fixing the pipe is fixedly installed on the limit frame; The limit frame comprises a limit sleeve embedded on the limit frame, a screw rod rotationally installed inside the limit sleeve, and a sliding connecting block sliding installed at the end of the limit sleeve. The sliding connecting block is arranged towards the pipeline. One end of the screw rod is fixedly installed with a lifting block, which is fixedly connected with the sliding connecting block through an extrusion spring, and the end of the sliding connecting block facing the pipeline is fixedly installed with a top block.

As a further solution of the present invention, an adjusting knob is fixedly installed on the upper end of the screw rod to drive the screw rod to rotate.

As a further solution of the present invention: the left and right sides of the lower part of the limiting sleeve are symmetrically provided with two vertical sliding grooves, and the upper end of the sliding connecting block protrudes toward the vertical sliding groove and is slidably installed in the vertical sliding groove internal.

As a further solution of the present invention, a transverse installation rod is arranged at the center of the inner frame, and the peripheral side of the transverse installation rod is fixedly connected to the inner wall of the inner frame through several connecting rods, and the transverse installation rod extends along the length of the pipeline.

As a further solution of the present invention, a buffer damping mechanism is arranged between the side edge of the inner frame and the installation groove.

As a further scheme of the invention, the buffer damping mechanism comprises a base and a buffer seat, the base is fixedly installed at the side of the inner frame, and the buffer seat is attached to the bottom of the installation slot; The left and right sides of the base are respectively fixedly connected with the bottom of the buffer seat through two telescopic rods, and the telescopic rod is sleeved with a damping spring.

As a further solution of the present invention, a plurality of laminated elastic shock-absorbing sheets is further arranged between the base and the buffer seat, and the upper end of the elastic shock-absorbing sheet is fixedly connected with the buffer seat.

As a further solution of the present invention: two hinged seats are symmetrically fixed on the left and right sides of the lower end of the elastic shock-absorbing sheet, two lateral sliding grooves are symmetrically opened on the left and right sides of the upper part of the base, and two lateral sliding grooves are slidably installed inside the lateral sliding grooves. The sliding block is fixedly connected with the transverse chute through the buffer spring, and the upper part of the sliding block is hinged with the hinge seat.

Compared with the prior art, the beneficial effects of the present invention are as follows: in the present invention, the limit frame is detachably installed on the outside of the outer frame of the installation groove, and the screw is screwed in to drive the lifting block to squeeze the compression spring, so that the top block squeezes the surface of the pipe to fix the pipeline. By setting the polygonal frame, it is possible to install multiple pipelines at the same time, and at the same time, under the connection and support of the support rod, the overall stability is improved.

### BRIEF DESCRIPTION OF THE DRAWINGS

FIG. 1 is a schematic structural diagram of a reinforced seismic structure suitable for an urban underground comprehensive pipe gallery.

FIG. 2 is a schematic structural diagram of a polygonal frame in a reinforced seismic structure suitable for an urban underground comprehensive pipe gallery.

FIG. 3 is a schematic structural diagram of the limiting mechanism in the reinforced seismic structure suitable for the urban underground comprehensive pipe gallery.

FIG. 4 is a schematic structural diagram of a buffering and shock absorbing mechanism in a reinforced seismic structure suitable for an urban underground comprehensive pipe gallery.

In the picture: 1—polygon frame, 101—outer frame, 102—installation slot, 103—inner frame, 104—support rod, 105—horizontal installation rod, 106—connecting rod, 2—limiting frame, 3—limiting Mechanism, 301—limiting sleeve, 302—screw, 303—adjusting knob, 304—lifting block, 305—extrusion spring, 306—vertical chute, 307—sliding connection block, 308—top block, 4—buffer Shock-absorbing mechanism, 401—base, 402—buffer seat, 403—elastic shock-absorbing sheet, 404—transverse chute, 405—slider, 406—buffer spring, 407—hinged seat, 408—telescopic rod, 409—shock absorber spring.

### DETAILED DESCRIPTION OF THE EMBODIMENTS

The technical solution of the present patent will be described in further detail below in conjunction with specific embodiments.

Embodiments of the present patent are described in detail below, examples of which are illustrated in the accompanying drawings, wherein the same or similar reference numerals refer to the same or similar elements or elements having the same or similar functions throughout. The embodiments described below with reference to the accompanying drawings are exemplary and are only used to explain the present patent, but should not be construed as a limitation on the present patent.

In the description of the present patent, it should be understood that the terms “center”, “top”, “bottom”, “front”, “back”, “left”, “right”, “vertical”, “horizontal”, “top”, “bottom”, “inside”, “outside” and other directions or positional relationships indicated are based on the directions or positional relationships shown in the drawings. It is only for the convenience of describing the patent and simplifying the description, rather than indicating or implying the device or the element must have a specific orientation, be constructed and operated in a specific orientation, so it cannot be understood as a limitation of this patent.

In the description of this patent, it should be noted that, unless otherwise expressly specified and limited, the terms “installed”, “connected”, “connected” and “arranged” should be understood in a broad sense, it can also be detachably connected and set, or integrally connected and set. For those of ordinary skill in the art, the specific meanings of the above terms in this patent can be understood according to specific situations.

### Example 1

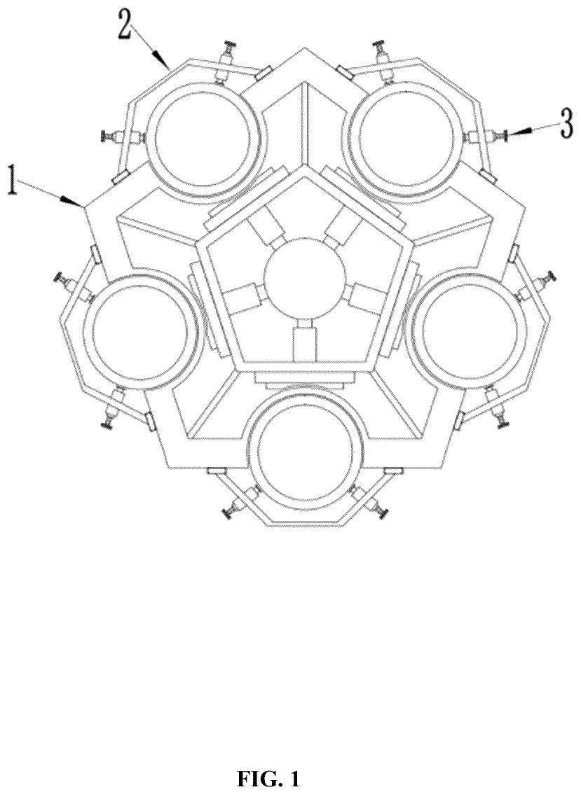

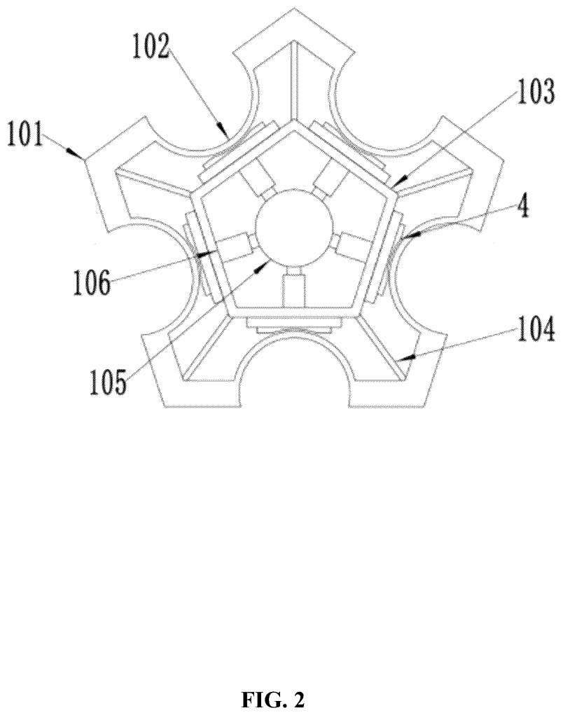

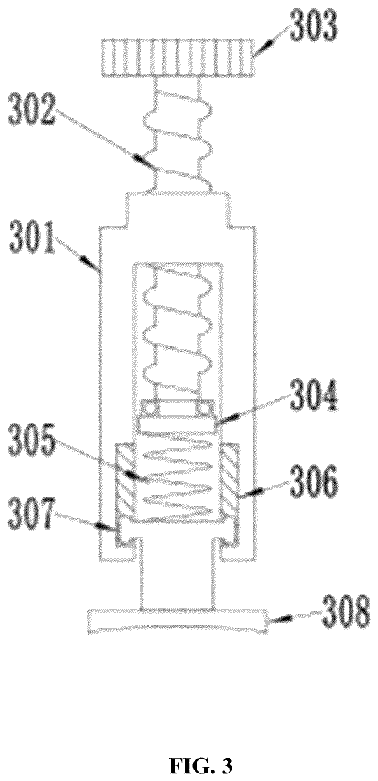

Referring to FIGS. 1 to 3, In the embodiment of the invention, an enhanced anti-seismic structure suitable for urban underground comprehensive pipe gallery comprises a polygonal frame 1, which comprises an outer frame 101 and an inner frame arranged inside the outer frame 101, the vertex of the inner frame 103 is fixedly connected with the bending position inside the outer frame 101 through the support rod 104; An installation slot 102 is arranged at the outer side of the outer frame 101 for pipeline installation. It can be understood that the installation slot 102 is one-to-one corresponding to the side of the outer frame 101, that is, the number of installation slots 102 is the same as the number of sides of the outer frame 101. The outer frame 101 is located at the outer side of the installation slot 102 and can be disassembled to install a limit frame 2. The limit frame 2 is fixedly installed with a limit mechanism 3 for fixing the pipe; The limit frame 3 comprises a limit sleeve 301 mounted on the limit frame 2, a screw rod 302 mounted inside the limit sleeve 301 and a sliding connection block 307 mounted at the end of the limit sleeve 301, which faces the pipe setting: one end of the screw rod 302 is fixedly installed with a lifting block 304, the lifting block 304 is fixedly connected with the sliding connection block 307 through the extrusion spring 305, the sliding connection block 307 is fixedly installed with a top block 308 toward one end of the pipe, and the screw rod 302 is screwed to drive the lifting block 304 to extrude the extrusion spring 305, so that the top block 308 extrudes the pipe surface, and the pipe is fixed. By setting a polygonal frame 1, multiple pipes can be installed at the same time, At the same time, under the connecting support of the support rod 104, the overall stability is improved.

In an embodiment of the present invention, an adjustment knob 303 is fixedly installed on the upper end of the screw rod 302 to drive the screw rod 302 to rotate;

In an embodiment of the present invention, two vertical sliding grooves 306 are symmetrically opened on the left and right sides of the lower part of the limiting sleeve 301, and the upper end of the sliding connecting block 307 protrudes toward the vertical sliding groove 306 and slidably installed inside the vertical chute 306;

In another embodiment of the present invention, a buffer damping mechanism 4 is provided between the side of the inner frame 103 and the installation groove 102. When the outer frame 101 is subjected to vibration, the buffer damping mechanism 4 absorbs the vibration, and the outer frame 101 and the outer frame 101 and pipes are protected.

In yet another embodiment of the present invention, a lateral mounting rod 105 is disposed at the center of the inner frame 103, and the peripheral side of the lateral mounting rod 105 is fixedly connected to the inner wall of the inner frame 103 through a plurality of connecting rods 106, and the lateral mounting rod 105 extending along the length of the pipe, it is used to fix the polygon frame 1 inside the pipe gallery;

Further, in the embodiment of the present invention, the connecting rod 106 is a telescopic structure, which is used to connect and fix the lateral installation rods 105 of different sizes.

### Example 2

Referring to FIGS. 1 to 3, In the embodiment of the invention, an enhanced anti-seismic structure suitable for urban underground comprehensive pipe gallery comprises a polygonal frame 1, which comprises an outer frame 101 and an inner frame arranged inside the outer frame 101, the vertex of the inner frame 103 is fixedly connected with the bending position inside the outer frame 101 through the support rod 104; An installation slot 102 is arranged at the outer side of the outer frame 101 for pipeline installation. It can be understood that the installation slot 102 is one-to-one corresponding to the side of the outer frame 101, that is, the number of installation slots 102 is the same as the number of sides of the outer frame 101. The outer frame 101 is located at the outer side of the installation slot 102 and can be disassembled to install a limit frame 2. The limit frame 2 is fixedly installed with a limit mechanism 3 for fixing the pipe; The limit frame 3 comprises a limit sleeve 301 mounted on the limit frame 2, a screw rod 302 mounted inside the limit sleeve 301 and a sliding connection block 307 mounted at the end of the limit sleeve 301, which faces the pipe setting: one end of the screw rod 302 is fixedly installed with a lifting block 304, the lifting block 304 is fixedly connected with the sliding connection block 307 through the extrusion spring 305, the sliding connection block 307 is fixedly installed with a top block 308 toward one end of the pipe, and the screw rod 302 is screwed to drive the lifting block 304 to extrude the extrusion spring 305, so that the top block 308 extrudes the pipe surface, and the pipe is fixed. By setting a polygonal frame 1, multiple pipes can be installed at the same time, At the same time, under the connecting support of the support rod 104, the overall stability is improved.

In an embodiment of the present invention, an adjustment knob 303 is fixedly installed on the upper end of the screw rod 302 to drive the screw rod 302 to rotate;

In an embodiment of the present invention, two vertical sliding grooves 306 are symmetrically opened on the left and right sides of the lower part of the limiting sleeve 301, and the upper end of the sliding connecting block 307 protrudes toward the vertical sliding groove 306 and slidably installed inside the vertical chute 306;

In another embodiment of the present invention, a buffer damping mechanism 4 is provided between the side of the inner frame 103 and the installation groove 102. When the outer frame 101 is subjected to vibration, the buffer damping mechanism 4 absorbs the vibration, and the outer frame 101 and the outer frame 101 and pipes are protected.

In yet another embodiment of the present invention, a lateral mounting rod 105 is disposed at the center of the inner frame 103, and the peripheral side of the lateral mounting rod 105 is fixedly connected to the inner wall of the inner frame 103 through a plurality of connecting rods 106, and the lateral mounting rod 105 extending along the length of the pipe, it is used to fix the polygon frame 1 inside the pipe gallery;

Further, in the embodiment of the present invention, the connecting rod 106 is a telescopic structure, which is used to connect and fix the lateral installation rods 105 of different sizes.

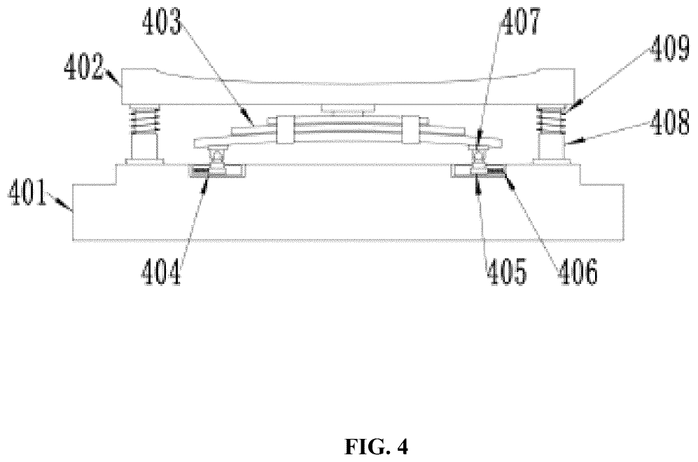

Please refer to FIG. 4, the difference between this embodiment and Embodiment 1 is:

The buffer damping mechanism 4 comprises a base 401 and a buffer seat 402, the base 401 is fixedly installed at the side of the inner frame 103, and the buffer seat 402 is attached to the bottom of the installation slot 102; The left and right sides of the base 401 are respectively fixedly connected with the bottom of the buffer seat 402 through two telescopic rods 408, and the telescopic rod 408 is sleeved with a damping spring 409;

Furthermore, in the embodiment of the invention, a number of laminated elastic shock absorbers 403 are also arranged between the base 401 and the buffer seat 402, the upper end of the elastic shock absorber 403 is fixedly connected with the buffer seat 402, two hinged seats 407 are symmetrically fixed on the left and right sides of the lower end of the elastic shock absorber 403, two lateral chutes 404 are symmetrically arranged on the left and right sides of the upper part of the base 401, and a slider 405 is installed inside the lateral chute 404, The sliding block 405 is fixedly connected with the transverse chute 404 through the buffer spring 406, and the upper part of the sliding block 405 is hinged with the hinge seat 407, so as to form a multiple buffer anti-seismic structure and improve the anti-seismic performance of the device.

The above are only the preferred embodiments of the present invention. It should be pointed out that for those skilled in the art, some modifications and improvements can be made without departing from the concept of the present invention, and these should also be regarded as the protection of the present invention. These will not affect the effect of the implementation of the present invention and the practicability of the patent.

What is claimed is:

1. A reinforced seismic structure suitable for an urban underground comprehensive pipe gallery, characterized in that it comprises a polygonal frame (1), the polygonal frame (1) includes an outer frame (101) and is arranged inside the outer frame (101) The inner frame (103) of the inner frame (103), the vertex of the inner frame (103) is fixedly connected with the bending part inside the outer frame (101) through the support rod (104); Installation grooves (102) for pipe installation, the installation grooves (102) correspond one-to-one with the sides of the outer frame (101), and the outer frame (101) is located at the outer side of the installation groove (102) and the limiter (2) is detachably installed), a limit mechanism (3) for fixing the pipe is fixedly installed on the limit frame (2); the limit frame (3) includes a limit sleeve inlaid on the limit frame (2) (301), a screw (302) that is rotatably installed inside the limiting sleeve (301), and a sliding connecting block (307) that is slidably installed at the end of the limiting sleeve (301), and the sliding connecting block (307) faces the pipeline A lifting block (304) is fixedly installed at one end of the screw rod (302), and the lifting block (304) is fixedly connected with the sliding connection block (307) through the compression spring (305), and the sliding connection block (307) faces the pipeline. A top block (308) is fixedly installed at one end.

2. The reinforced anti-seismic structure suitable for an urban underground comprehensive pipe gallery according to claim 1, characterized in that, an adjustment knob (303) is fixedly installed on the upper end of the screw (302).

3. The reinforced anti-seismic structure suitable for an urban underground comprehensive pipe gallery according to claim 2, characterized in that two vertical chutes (306) are symmetrically opened on the left and right sides of the lower part of the limiting sleeve (301), the upper end of the sliding connection block (307) protrudes toward the vertical chute (306) and is slidably installed inside the vertical chute (306).

4. The reinforced anti-seismic structure suitable for urban underground comprehensive pipe gallery according to claim 1, characterized in that, a transverse installation rod (105) is provided at the center of the inner frame (103), and the transverse installation rod (105) is the peripheral side is fixedly connected with the inner wall of the inner frame (103) through a plurality of connecting rods (106), and the transverse mounting rods (105) extend along the length direction of the pipeline.

5. The enhanced anti-seismic structures applicable to urban underground comprehensive pipe gallery according to claim 1, which is characterized in that a damping mechanism (4) is arranged between the side of the inner frame (103) and the installation slot (102).

6. The reinforced anti-seismic structure suitable for an urban underground comprehensive pipe gallery according to claim 5, characterized in that the buffering and shock-absorbing mechanism (4) comprises a base (401) and a buffering base (402), and the base (401) is fixedly installed at the side of the inner frame (103), and the buffer seat (402) is attached to the bottom of the installation groove (102). The bottom of the seat (402) is fixedly connected, and a shock-absorbing spring (409) is sleeved on the telescopic rod (408).

7. The reinforced anti-seismic structure suitable for an urban underground comprehensive pipe gallery according to claim 6, characterized in that, between the base (401) and the buffer seat (402), a plurality of laminated elastic shock-absorbing sheets (403), the upper end of the elastic shock-absorbing sheet (403) is fixedly connected with the buffer seat (402).

8. The enhanced anti-seismic structure suitable for urban underground comprehensive pipe gallery according to claim 7, which is characterized in that two hinged seats (407) are symmetrically and fixedly installed on the left and right sides of the lower end of the elastic shock absorber (403), two transverse chutes (404) are symmetrically arranged on the left and right sides of the upper part of the base (401), a sliding block (405) is installed on the inner sliding of the transverse chute (404), and the sliding block (405) is fixedly connected with the transverse chute (404) through a buffer spring (406). The upper part of the sliding block (405) is hinged with the hinge seat (407).
